(19) United States
(12) Patent Application Publication
(10) Pub. No.: US 2007/0116931 A1
(43) Pub. Date: May 24, 2007

(54) Three-in-one decorative plate

(75) Inventor: Jui-Chen Lu, Taoyuan City (TW)

Correspondence Address: TROXELL LAW OFFICE PLLC, Suite 1404, 5205 Leesburg Pike, Falls Church, VA, 22041, US

(73) Assignee: Taiwan Floor Co.

(21) Appl. No.: 11/284,823

(22) Filed: Nov. 23, 2005

(51) Int. Cl. B32B 3/30

(52) U.S. Cl. 428/167; 428/60

(57) ABSTRACT

A three-in-one decorative plate comprises a faceplate, a bottom plate, and a foamed pad, wherein the bottom plate has several transverse cutting grooves spaced at predetermined intervals along identical directions such that the three-in-one decorative plate is flexible and that no gap is formed between the three-in-one decorative plate and the ground. Because the bottom plate of the present invention has several transverse cutting grooves, the cutting process of the three-in-one decorative plate can be completed rapidly and easily by merely cutting the thinner faceplate of the three-in-one decorative plate along cutting lines of the transverse cutting grooves.

### FIELD OF THE INVENTION

The present invention relates to a three-in-one decorative plate that is applicable to the wall, the ground, and the ceiling, and more practically to a three-in-one decorative plate that is slightly flexible and can be cut according to practical need.

### BACKGROUND OF THE INVENTION

Generally speaking, the general DIY-able decorative plates, which are applied to the ground or the wall, have fixed size and specification such that the consumers can assembly the decorative plates together easily by themselves. However, the wood decorative plates that can be assembled by the consumers are only suitable for flat surfaces. If there is slight roughness on the ground or the wall, many gaps are thus formed since the conventional decorative plates are not conformal to the ground or the wall.

### SUMMARY OF THE INVENTION

In view of the drawbacks of the conventional DIY-able decorative plate that is unable to closely attach to the slightly rough ground or wall, the present inventor invents a three-in-one decorative plate for overcoming the conventional drawbacks based on many years of experience in this art.

It is a major object of the present invention to provide a three-in-one decorative plate that is applicable to the wall, the ground, or the ceiling with slight roughness by use of several transverse cutting grooves, wherein the transverse cutting grooves are formed on the bottom plate and spaced at predetermined intervals. As a result, after assembled, the three-in-one decorative plate of the preset invention is conformal to the rough ground or the curved wall to avoid the occurrence of gap between the three-in-one decorative plate and the ground (or the wall).

It is another object of the present invention to provide a three-in-one decorative plate that is DIY-able and can be cut easily. The bottom plate has several transverse cutting grooves spaced at predetermined intervals along identical directions. If there is a need to cut off parts of the three-in-one decorative plate, the cutting process can be performed by merely cutting the faceplate of the three-in-one decorative plate along cutting lines of the transverse cutting grooves such that the DIY process is practicable and can be performed easily.

It is still another object of the present invention to provide a foamed pad for fixing the three-in-one decorative plate, wherein the foamed pad is practically mounted on the back of the bottom plate. As a result, the three-in-one decorative plate is more stable and provides the moisture-proof and soundproof effects.

### BRIEF DESCRIPTION OF THE DRAWINGS

FIG. 1 is a three-dimensional view showing the appearance of the present invention.

FIG. 2 is an exploded, three-dimensional view showing the structure of the present invention.

FIG. 3 is a cross-sectional view taken along line 3-3 of FIG. 1 in the direction of arrows.

FIG. 4 is a schematic view showing that the structure of the present invention is flexible.

FIG. 5 is a partially enlarged, cross-sectional view showing an encircled region A of FIG. 3.

FIG. 6 is a schematic view showing that the structure of the present invention is applied to the rough ground.

FIG. 7 is a three-dimensional view showing that a release paper is torn off from a decorative plate of the present invention.

FIG. 8 is a schematic view showing that several decorative plates of the present invention are assembled together.

### DETAILED DESCRIPTION OF THE PREFERRED EMBODIMENT

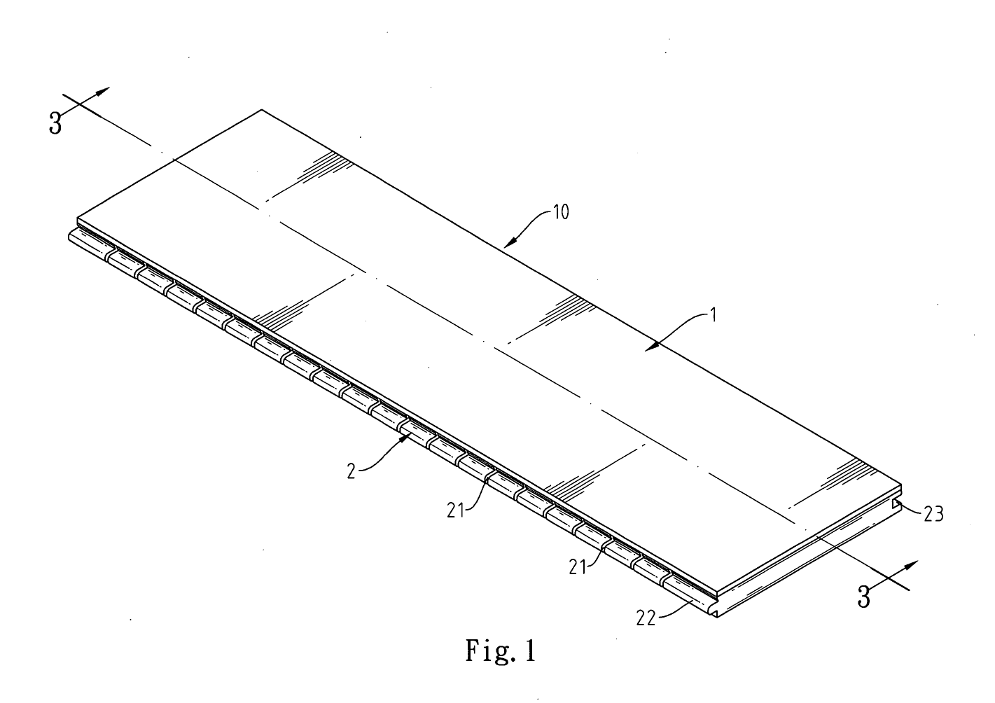

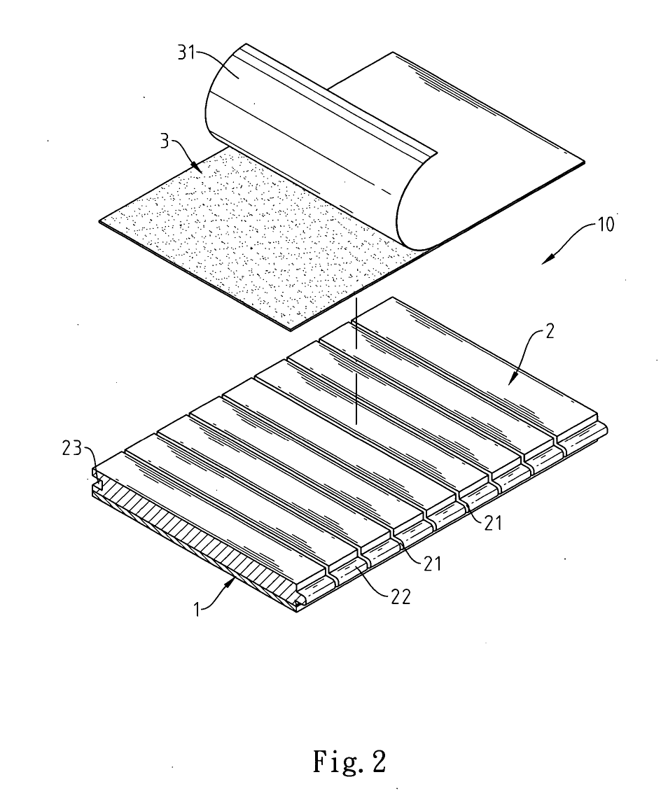

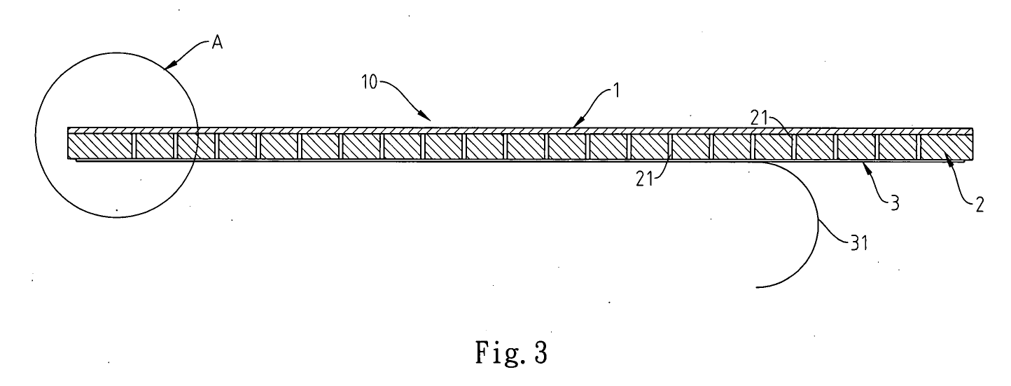

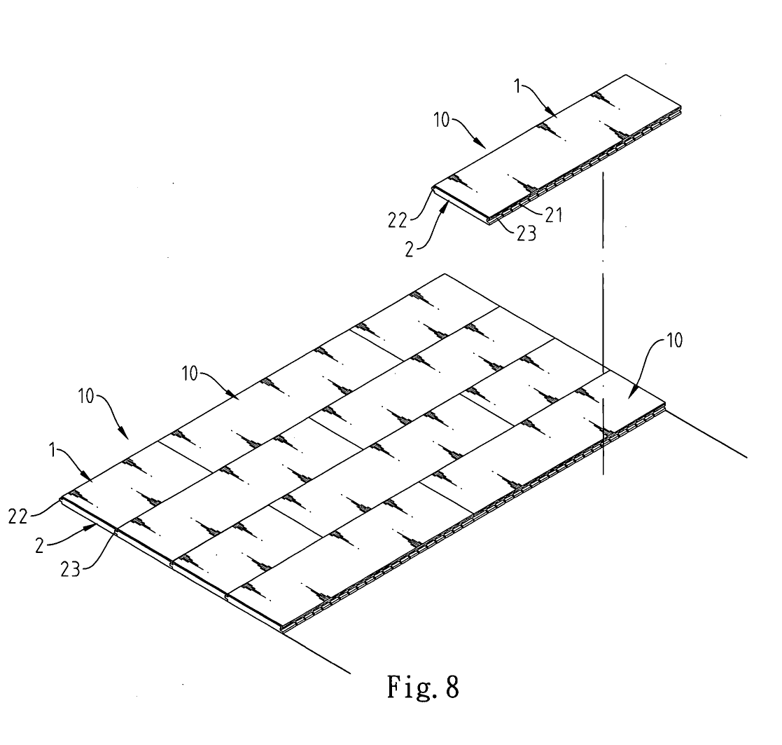

Referring to FIG. 1 through FIG. 3 and FIG. 8, a three-in-one decorative plate 10 comprises a faceplate 1 and a bottom plate 2, wherein the bottom plate 2 is mounted on the back of the faceplate 1, and the bottom plate 2 has several transverse cutting grooves 21, which are spaced at predetermined intervals along identical directions. In addition, a raised edge 22 and a recessed trench 23 are mounted on two opposite sides of the bottom plate 2 so as to attach the three-in-one decorative plate 10 to other three-in-one decorative plates.

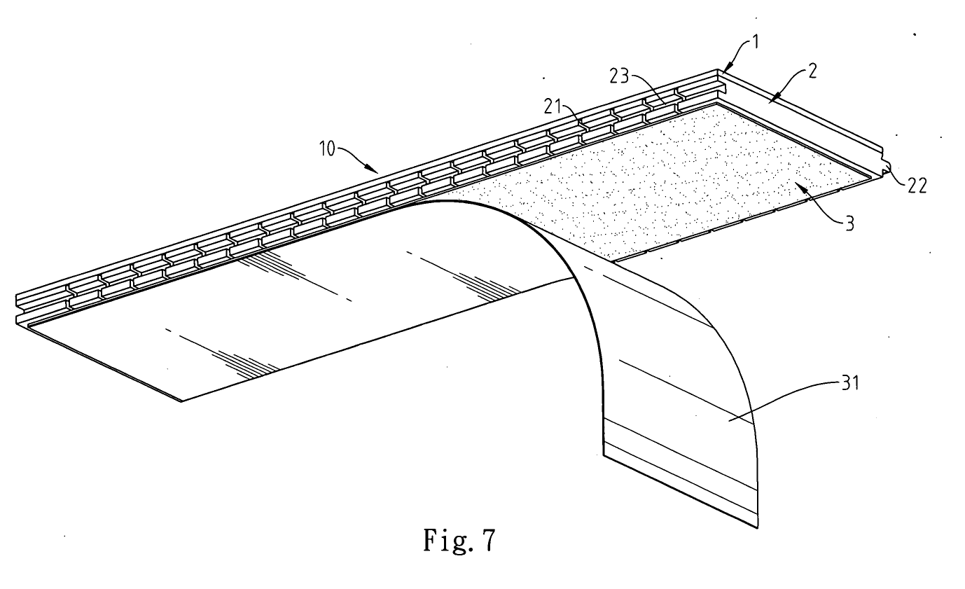

For the purpose of fixing the three-in-one decorative plate 10, a layer of moisture-proof and soundproof foamed pad 3 (as shown in FIG. 7) is mounted on the back of the bottom plate 2. After a release paper 31 that mounts on the back of the foamed pad 3 is torn off, the three-in-one decorative plate 10 can be fixedly adhered to the ground, the ceiling, or the wall besides being attached to the other three-in-one decorative plates. The foamed pad 3 that mounts on the back of the bottom plate 2 increases the stability and is also moisture-proof and soundproof.

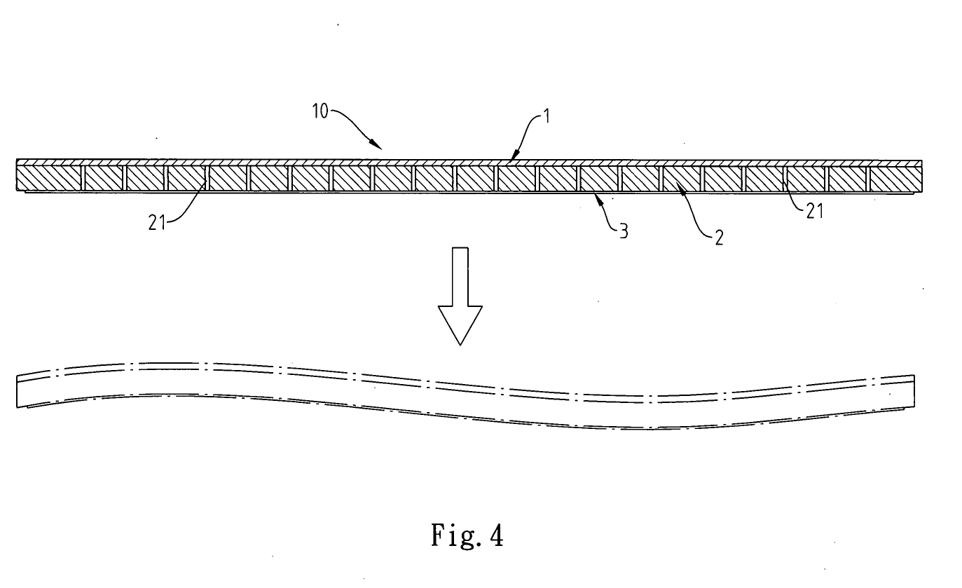

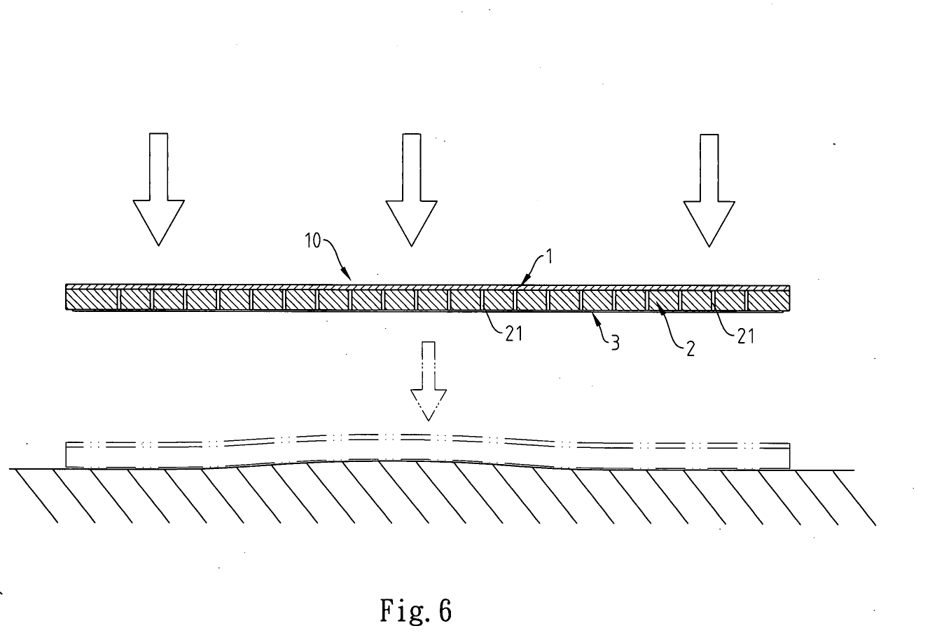

Referring to FIG. 4 and FIG. 6, when the three-in-one decorative plate 10 of the present invention is attached to the ground (or the wall), the attached three-in-one decorative plate 10 is slightly flexible and conformal to the slight roughness of the ground since the faceplate 1 is thin enough and the bottom plate 2 has several cutting grooves 21. As a result, no gap is formed between the three-in-one decorative plate 10 and the ground. Besides, no noise is produced when walking on the three-in-one decorative plate 10.

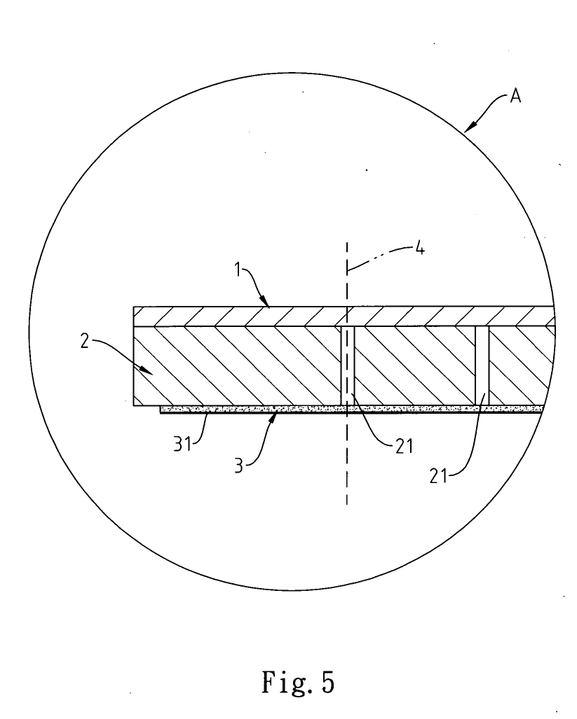

Referring further to FIG. 5, the required amount and size of the three-in-one decorative plate 10 are generally varied according to an area of an indoor room. Accordingly, there is a need to cut the three-in-one decorative plate 10 to conform to the area of the indoor room. On one hand, it is very difficult to cut the conventional decorative plate since the conventional decorative plate has a certain thickness. Besides, the person who is not skilled in this art must spend much more time on cutting this conventional decorative plate perfectly. In other words, the cutting of the conventional decorative plate is a technical skill for the general consumers. On the other hand, because the bottom plate 2 of the present invention has several transverse cutting grooves 21, the cutting process of the three-in-one decorative plate 10 can be completed rapidly and easily by merely cutting the faceplate 1 of the three-in-one decorative plate 10 along cutting lines 4 of the transverse cutting grooves 21.

What the invention claimed is:

1. A three-in-one decorative plate having a faceplate, a bottom plate, and a foamed pad, characterized in that:
said bottom plate has a plurality of transverse cutting grooves spaced at predetermined intervals along identical directions; and
said foamed pad that attaches to the bottom plate is moisture-proof and soundproof.
